(19) United States
(12) Patent Application Publication
(10) Pub. No.: US 2003/0141611 A1
(43) Pub. Date: Jul. 31, 2003

(54) Adjustable shroud for spinning synthetic yarns

(76) Inventor: Kenneth Charles Giese, Huntersville, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/056,675

(22) Filed: Jan. 25, 2002

(51) Int. Cl. G01B 1/00; B29C 47/60

(52) U.S. Cl. 264/40.1; 425/72.2; 425/73; 264/211.22

(57) ABSTRACT

The present invention concerns an adjustable shroud useful with any melt spinable polymers during their production. The adjustable shroud can be produced from different embodiments such as hinged wall sections, bellows, or collapsible or nesting walls. The adjustable shroud may be controlled by means of hydraulics, pneumatics, mechanical worm screws powered by an electrical motor or manually, or any other suitable means obvious to those skilled in the art. The length of the adjustable shroud functions such that it extends toward or away from the spinneret depending on the desired length of the shroud.

### BACKGROUND OF THE INVENTION

1) Field of the Invention

The present invention relates to an adjustable shroud for controlling the thermal environment around synthetic yarn, as the yarn exits the spinneret. The cooling rate of yarn affects a number of physical and mechanical properties of the yarn. The adjustable shroud controls the cooling rate, thereby controlling the physical and mechanical properties of the yarns. The present invention is particularly useful when switching from one yarn type to another that requires a different length shroud. The adjustability of the shroud may be accomplished by pneumatic means, hydraulic means, electric motors, or done manually. Preferably pneumatic or hydraulic means are employed that are controlled by computer.

2) Prior Art

Fibers are broadly used in industrial applications such as automobile tires, v-belts, conveyor belts, and the like. Fibers are also used in textile applications such as sewing thread, woven and nonwoven fabric, and knitted fabric. The manufactured fibers of the present invention are conventionally spun from a melt through a plurality of orifices in a spinneret. Many physical and mechanical properties of the fibers depend on the polymer, the temperature of the polymer, the rate at which the fiber is spun and the quenching of the yarn, all of which effect the cooling rate. Thus when the yarn denier or number of filaments change, the shroud length needs to be optimized for these changes.

In a conventional system, polymer is extruded through a spinneret to form fibers and cooled at a rate in part determined by the shroud length and the quench characteristics, if any. The shroud functions primarily to delay the cooling and to increase the draw down prior to quenching. Depending upon the fiber use, the length of the shroud may be from about 50 mm to about 500 mm. The cross section of the shroud preferably conforms approximately to the dimensions of the spinneret. Typically the spinneret is rectangular or round. However a round or oval shroud can be used with a rectangular pack, and a rectangular shroud with a round pack. In order to effect any necessary changes in the aforementioned properties, generally the length of the shroud must be changed. Often, a set of shrouds of varying lengths is designed. The product changeover requires that production be halted, the existing shroud removed from each spinneret, and a new shroud installed that is compatible with the new product specifications. In so doing, up to 8 hours of production may be lost for every changeover.

U.S. Pat. No. 4,690,866 to Kumakawa et al. discloses a set of shrouds of different lengths. In Table 1, reference is made to the length (in mm) of the heating zone below the spinneret. The shroud length varies between 100 to 300 mm.

The key object of the present invention is to provide an adjustable shroud for synthetic yarn production such that changeover from one yarn product to another may be accomplished with minimal disruption to yarn production.

### SUMMARY OF THE INVENTION

The present invention consists of an adjustable shroud employed in a synthetic yarn production system. The length of the shroud may be adjusted without disruption in production whereby the changeover time is reduced from about 8 hours to a fraction of an hour. The shroud having adjustable length is positioned adjacent the spinnerets such that the molten polymer exits from the spinneret, passes through the shroud, and continues to other known equipment and processes.

In the broadest sense, the present invention relates to a shroud having means to adjust the length of the shroud.

### BRIEF DESCRIPTION OF THE DRAWINGS

The foregoing and other objects will become more readily apparent by referring to the following detailed description and the appended drawing in which:

FIG. 1 is a cross section of a conventional fixed length shroud positioned beneath the spinneret.

FIG. 2 is a cross section of a first embodiment of an adjustable shroud positioned beneath the spinneret according to the present invention.

FIG. 3 is a cross section of a second embodiment of an adjustable shroud according to the present invention.

FIG. 4 is a cross section of a third embodiment of an adjustable shroud according to the present invention.

### DETAILED DESCRIPTION OF THE PREFERRED EMBODIMENTS

The present invention relates to an adjustable shroud for controlling the thermal environment around synthetic yarn, as the yarn exits the spinneret. The cooling rate of yarn affects a number of physical and mechanical properties of the yarn. The adjustable shroud controls the cooling rate, thereby controlling the physical and mechanical properties of the yarns. The present invention is particularly useful when switching from one yarn type to another that requires a different length shroud.

Because yarn properties are a strong function of the shroud length, the mechanism to position and reposition the shroud should be precise—within 1 to 2 mm. The adjustability of the shroud may be accomplished by pneumatic means, hydraulic means, electric motors, or done manually. Preferably pneumatic or hydraulic means are employed that are controlled by computer. The details of computer control and its relationship to pneumatic, hydraulic or electrical motors means to position the shroud are not a part of the present invention.

The present invention is useful with any melt spinnable polymers such as polyesters, polyamides, or polyolefins or a combination of these. Suitable polyesters are polyethylene terephthalate, polypropylene terephthalate, polybutylene terephthalate, polyethylene naphthalate, polyethylene bibenzoate, or copolyesters such as polyethylene terephthalate-isophthalate or polyethylene naphthalate-bibenzoate, or mixture of two or more of these. Suitable polyamides are nylon 6 or nylon 6,6, or a mixture thereof. Suitable polyolefins are polyethylene, polypropylene, polybutylene, or a mixture of two or more of these.

FIG. 1 illustrates the prior art in which a fixed shroud generally indicated by reference 10 comprises a wall 12. The wall 12 may be a continuous circular wall, if the shroud is circular, or the wall may be quadrilateral, for example. The shroud 10 is generally secured to a supporting structure 14 which typically is a dowbox employed to keep the polymer molten, however any structure capable of supporting the weight of the shroud is sufficient for the present invention. The shroud is secured to the supporting structure 14 by means of bolts 16 (two are illustrated but the actual number is whatever is necessary to support the shroud in a secure manner). The supporting structure 14 surrounds the pack 18 which contains molten polymer. At the bottom of the pack 18 is a typical spinneret 20. The use of spinnerets is well known to those skilled in the art and the spinneret shown in FIG. 1 only serves to illustrate the position of the shroud relative to the pack. The shroud 10, may optionally have one or more heaters 22 which may be in the form of electrical elements, or tubing for a heated fluid (such as liquid or steam). Typically the shroud 10 has electric elements 22 in its sidewall.

In operation, the prior art system shown in FIG. 1 contains molten polymer in the pack 18 under pressure such that it is extruded through the small holes (not specifically shown) in the spinneret 20 forming a plurality of filaments 24 that can be combined to make a yarn.

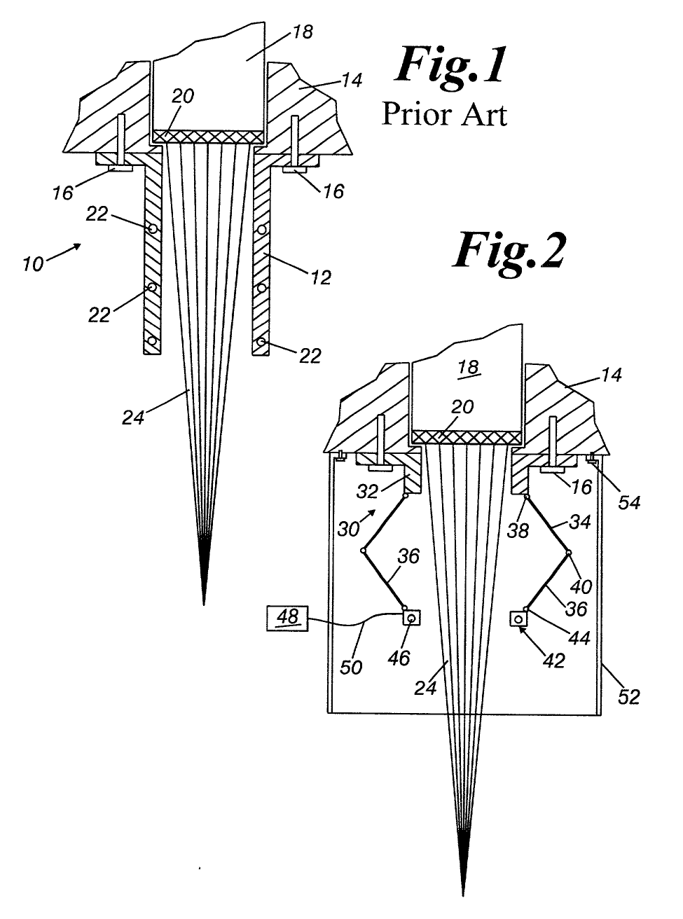

FIGS. 2-4 demonstrate the embodiments of the present invention. Where reference numerals are the same as those in FIG. 1, the elements described are the same.

FIG. 2 illustrates a quadrilateral adjustable shroud generally indicated by reference numeral 30. The adjustable shroud 30 is secured to the supporting structure 14 by bolts 16 in similar fashion described relative to FIG. 1. The adjustable shroud 30 comprises an upper section 32 which is secured to the supporting structure 14. The adjustable shroud also comprises folding walls 34 and 36. Wall 34 is secured to the upper section 32 by means of a hinge 38. Additionally, the wall 34 is secured to wall 36 by a hinge 40. Lastly, the lower portion of the adjustable shroud 30 includes a lower wall segment 42 which is likewise hinged to the folding wall 36 by means of a hinge 44. Typically, the lower wall segment 42 may optionally contain a heating element 46 similar to those disclosed in the FIG. 1 prior art device. In addition to the folding wall sides 34, 36 the adjustable shroud 30 has two fixed walls in sliding contact with the folding walls, only one of which is shown and is indicated by reference numeral 52. The function of the fixed walls is to seal the adjustable shroud 30. Preferably the edges of the folding walls 34 and 36 are covered with an insulating fabric to insure sealing. The fixed walls are attached to the supporting structure 14 by bolts 54 and they are in close proximity to the upper section 32 and the lower segment 42. An optional control mechanism 48 may be linked with the adjustable shroud 30 via link 50 which functions to move the lower wall segment 42 up or down (toward the spinneret 20, or away from it). To adjust the shroud length it is not necessary that there is a control 48, since the device could be manually positioned, for example. However, it is also contemplated that the adjustable shroud 30 can be moved by a control 48 through its link line 50 by electric powered mechanical worm screw pneumatic or hydraulic systems (where link line 50 would be an air line or hydraulic line respectively) well known to those skilled in the art. The mechanism to position and reposition the adjustable shroud 30 should be precise—within 1 to 2 mm.

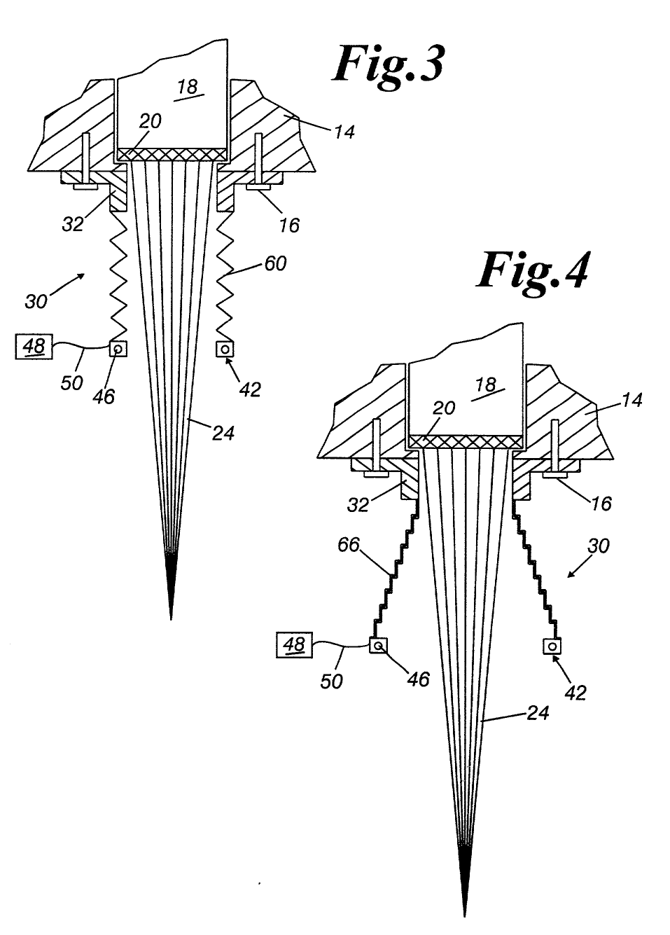

FIG. 3 is a second embodiment of the present invention, which can be round, oval or quadrilateral. In this embodiment the adjustable shroud 30 is also secured to the supporting structure 14 by means of bolts 16. Additionally, the adjustable shroud 30 has the upper section 32 and the lower wall segment 42 which may optionally contain the heater 46. Between the upper section 32 and the lower wall segment 42 are bellows 60 which may be circular, oval or quadrilateral in shape. The bellows 60 may be constructed in part mineral fibers such as mica wool, asbestos, glass wool fibers, and other materials that can withstand the temperature. The movement toward and away from the spinneret may optionally be controlled by control 48 through line link 50 as was previously discussed, or the entire adjustable shroud may be adjusted manually.

With reference to FIG. 4 which shows a third embodiment of the present invention, which can be round, oval or quadrilateral, again similar reference numerals indicate identical apparatus. However, instead of using bellows as shown in FIG. 3, a series of collapsible wall sections (nesting walls) are employed. In FIG. 4, the adjustable shroud 30 is shown extended to its maximum length. Any material that can withstand the temperature would be suitable for the collapsible wall sections 66, such as metal, certain plastics, glass, fiberglass, composite materials, etc. The collapsible wall sections 66 may be circular, oval or quadrilateral in shape. Optionally a control 48 with a link line 50 may be employed to move the adjustable shroud toward and away from the spinneret 20. Otherwise, the adjustment of the adjustable shroud 30 may be done manually.

Thus, it is apparent that there has been provided, in accordance with the invention, an adjustable shroud that fully satisfies the objects, aims, and advantages set forth above. While the invention has been described in conjunction with specific embodiments thereof, it is evident that many alternatives, modifications, and variations will be apparent to those skilled in the art in light of the foregoing description. According, it is intended to embrace all such alternatives, modifications, and variations as fall within the spirit and broad scope of the invention.

What is claimed is:

1) An adjustable shroud for use in a melt spinning process having a spinneret, comprising: an adjustable shroud, said shroud having means to secure it in close proximity to a spinneret, and means to adjust the length of the shroud.

2) The adjustable shroud of claim 1, wherein said adjustable shroud is quadrilateral, oval or circular in cross-section.

3) The adjustable shroud of claim 2, wherein two fixed walls form said quadrilateral shroud with two folding walls.

4) The adjustable shroud of claim 1, wherein said shroud is in the form of a bellows or of nesting walls.

5) The adjustable shroud of claim 1, wherein said means to adjust the length of said shroud is pneumatic, hydraulic, or one or more mechanical worm screws.

6) The adjustable shroud of claim 1, wherein said shroud contains heating means.

7) The combination of an adjustable shroud and a spinneret, comprising a spinneret for producing synthetic fibers; an adjustable shroud having means to secure it in close proximity to said spinneret, and means to adjust the length of the shroud; said shroud containing heating means.

8) The combination of claim 7, wherein said adjustable shroud is quadrilateral, oval or circular in cross-section.

9) The combination of claim 8, wherein two fixed walls form said quadrilateral shroud with two folding walls.

10) The combination of claim 7, wherein said shroud is in the form of a bellows or of nesting walls.

11) The combination of claim 7, wherein said means to adjust the length of said shroud is pneumatic, hydraulic, or one or more mechanical worm screws.

12) A melt spinning process for making synthetic fiber, comprising: a) determining the optimum cooling and draw down ratio of said fibers; b) adjusting the shroud length to obtain the optimum cooling and draw down ratio; c) spinning fibers from a polymer melt; and d) passing said spun fibers through said shroud.

13) The melt spinning process of claim 12, wherein said adjustable shroud is quadrilateral, oval or circular in cross-section.

14) The melt spinning process of claim 13, wherein two fixed walls form said quadrilateral shroud with two folding walls.

15) The melt spinning process of claim 12, wherein said shroud is in the form of a bellows or of nesting walls.

16) The melt spinning process of claim 12, wherein adjusting said length of said shroud is accomplished by pneumatic, hydraulic, or one or more mechanical worm screws.

17) The melt spinning process of claim 12, further including the step of heating said spun fibers as they pass through said shroud.
